(19) United States
(12) Patent Application Publication
(10) Pub. No.: US 2022/0178325 A1
(43) Pub. Date: Jun. 9, 2022

(54) CAMSHAFT PHASE ERROR MONITORING

(71) Applicant: JAGUAR LAND ROVER LIMITED, Warwickshire (GB)

(72) Inventor: Adam MOORCROFT, Whitley, Coventry, Warwickshire (GB)

(21) Appl. No.: 17/600,663

(22) PCT Filed: Apr. 3, 2020
(86) PCT No.: PCT/EP2020/059550

§ 371 Date: Oct. 1, 2021

(30) Foreign Application Priority Data
Apr. 4, 2019 (GB) 1904746.3

(51) Int. Cl. F02D 41/22; F02D 13/02; F02D 41/14; F02D 41/00; F02D 41/18

(52) U.S. Cl. CPC F02D 41/221; F02D 13/0226; F02D 41/1401; F02D 2200/0402; F02D 41/18; F02D 2041/1433; F02D 41/009

(57) ABSTRACT

Aspects of the present invention relate to a control advanced system for controlling a valve actuator for an internal combustion engine, the control system comprising one or more controllers, the control system being configured to: receive a requirement signal retarded indicative of a requirement for valve actuation with a first valve timing characteristic; receive an expected flow signal indicative of expected mass flow rate of air, associated with the first valve timing characteristic; control the valve actuator to provide the first valve timing characteristic; receive an actual flow signal indicative of actual mass flow rate of air, associated with the control of the valve actuator; cause comparison of the actual flow signal with the expected flow signal; and cause an action to be performed in dependence on the comparison, wherein the action comprises a compensation action and/or a fault reporting action and/or determining camshaft phase information.

### TECHNICAL FIELD

The present disclosure relates to a control system and method for controlling a valve actuator for an internal combustion engine. In particular, but not exclusively it relates to a control system, an internal combustion engine, a vehicle and a method for controlling a valve actuator for an internal combustion engine for camshaft phase error monitoring.

### BACKGROUND

Valve actuators for actuating poppet valves (‘valves’ herein) of internal combustion engines (‘engines’ herein) are known.

Some valve actuators provide a fixed valve lift profile. Some valve actuators comprise a varying device for varying valve timing and/or valve lift. For instance, an example electrohydraulic continuously variable valve lift (OWL) valve actuator is camshaft driven. A lobe on the camshaft pushes (lifts) a first piston which displaces hydraulic fluid within a hydraulic circuit. The hydraulic fluid is routed to a second piston which is coupled to a stem of a valve. A solenoid valve is provided as a varying device for varying displacement of the valve, to control valve timing and valve lift. When the solenoid valve is open, the hydraulic fluid displacement is directed to an outlet coupled to a reservoir, and the valve does not lift. When the solenoid valve is closed, the hydraulic fluid displaces the second piston to lift the valve. Controlling valve opening timing and/or closing timing can provide a target valve opening duration and/or target peak valve lift. For example, valve lift can be reduced by retarding valve opening timing and/or by advancing valve closing timing.

The term ‘continuously’ in OWL refers to the ability to control valve timing/lift in dozens, hundreds or more unique combinations of valve opening time and closing time within a lift profile envelope dictated by the shape of the lobe, enabling substantially continuous variation of valve lift. Lift variation is enabled by precisely varying the actuation time of the varying device within a combustion cycle, with respect to crankshaft angle, on a combustion cycle by combustion cycle basis.

Timing of actuation of the varying device is calibrated according to the assumed fixed relationship (‘phase’ herein) between the angular position of the camshaft relative to the angular position of the crankshaft coupled to the camshaft via a chain, belt or gears. However, due to production tolerances and chain stretch or belt stretch over time, or gear tooth misalignment during servicing, there can be a variation in the actual phase of the camshaft relative to the required phase of the camshaft. The actual valve lift can therefore vary compared to the expected valve lift for a given varying device actuation. This introduces uncertainty into the control of air charges, affecting engine efficiency.

Consider a scenario in which the valve actuator is configured to activate valve lift (i.e. close the solenoid valve) at the assumed start of an opening flank of the lobe, and deactivate valve lift (i.e. open the solenoid valve) at the assumed end of a closing flank of the lobe. If the camshaft phase is retarded relative to its intended phase, a base circle of the camshaft may be in contact with the first piston during a first period of rotation of the camshaft when valve lift is activated. Therefore, the valve will not start to open immediately, as intended. The valve will close abruptly before reaching the end of the closing flank of the lobe because the valve lift is deactivated before the valve has closed. Likewise, if the camshaft phase is advanced relative to its intended phase, the first piston may be in contact with the lobe at a location part way along the opening flank of the lobe when valve lift is activated, so the peak valve lift will be less than intended and the valve will close earlier than intended.

Camshaft phase error for the intake side of the engine may result in an incorrect air charge being admitted into the engine by intake valves, and therefore an incorrect air-fuel ratio. An incorrect air-fuel ratio can reduce fuel efficiency, increases the risk of knock, and can damage exhaust gas treatment systems. Camshaft phase error for the exhaust side of the engine results in poor evacuation of exhaust gases, which can also result in an incorrect air-fuel ratio for the next combustion cycle.

One solution would be to provide a camshaft position sensor to monitor whether a camshaft phase error is present, and to compensate engine control based on the camshaft phase error. Another solution would be to provide a variable camshaft timing system (e.g. camshaft phaser) to adjust the angular position of the camshaft relative to the angular position of the crankshaft, to compensate for camshaft phase error and chain/belt stretching or gear tooth misalignment. However, variable camshaft timing systems and camshaft position sensors are expensive and add to the number of components that can fail.

### SUMMARY OF THE INVENTION

It is an aim of the present invention to address one or more of the disadvantages associated with the prior art. Aspects and embodiments of the invention provide a control system, an internal combustion engine, a vehicle and a method as claimed in the appended claims.

According to an aspect of the invention there is provided a control system for controlling a valve actuator for an internal combustion engine, the control system comprising one or more controllers, the control system being configured to: receive a requirement signal indicative of a requirement for valve actuation with a first valve timing characteristic; receive an expected flow signal indicative of expected mass flow rate of air, associated with the first valve timing characteristic; control the valve actuator to provide the first valve timing characteristic; receive an actual flow signal indicative of actual mass flow rate of air, associated with the control of the valve actuator; cause comparison of the actual flow signal with the expected flow signal; and cause an action to be performed in dependence on the comparison, wherein the action comprises a compensation action and/or a fault reporting action and/or determining camshaft phase information.

An advantage is that the cost of an engine can be reduced because a camshaft position sensor is no longer required for detecting camshaft phase error. This is based on the realisation that valve timing characteristics could be controlled to perform a camshaft phase error function (diagnostic) normally associated with a camshaft position sensor, enabling the internal combustion engine to be optionally provided without the camshaft position sensor. This goes against conventional wisdom that engines, and particularly CVVL valve actuators requiring accurate camshaft information, should be provided with camshaft position sensors.

In some examples, the valve actuator enables at least variable valve timing for a fixed-phase camshaft internal combustion engine, and optionally enables variable valve lift. In some examples, the valve actuator enables substantially continuous adjustment of at least valve timing characteristics. In some examples, the valve actuator is an electrohydraulic valve actuation system or an electromagnetic valve actuation system. The valve actuator may provide CVVL. An advantage for a fixed-phase camshaft is that no camshaft phaser is provided which could influence the camshaft phase error. Another advantage is that the valve actuator supports examining the effect of small changes in valve timing on airflow, to more accurately assess the camshaft phase error.

In some examples, the first valve timing characteristic comprises late valve opening and/or early valve closing. In some examples, the first valve timing characteristic is associated with a valve-open duration, and wherein a magnitude of variation of the actual flow signal from the expected flow signal decreases for greater valve-open durations.

In some examples, the compensation action influences control of a vehicle subsystem to reduce the difference between actual and expected flow signals and/or influences control of a vehicle subsystem to reduce the effect of the difference on one or more engine characteristics. In some examples, the vehicle subsystem comprises one or more of: the valve actuator; a throttle valve; a forced induction subsystem; an air bypass valve; or an exhaust gas recirculation subsystem. An advantage is a more efficient engine despite having a camshaft phase error.

In some examples, the fault reporting action causes a fault indicator to be stored that indicates that a discrepancy exists between actual and expected camshaft angular position relative to crankshaft angular position. An advantage is a more durable engine as the fault will be noticed.

In some examples, at least the actual mass flow rate of air is determined using an air flow model capable of measuring a quantity of air inducted into the internal combustion engine using information from one or more sensors. An advantage is that the diagnostic can utilise existing sensors such as MAF (mass air flow) sensors.

In some examples, the expected mass flow rate comprises an expected quantity of a mass flow rate of air.

In some examples, the expected flow rate comprises an expected sign of a difference in mass flow rate of air when changing from a second valve timing characteristic to the first valve timing characteristic. An advantage is that the sign of the difference indicates whether the camshaft phase is retarded or advanced.

In some examples, the action is caused to be performed in dependence on the expected sign being negative and the actual sign being positive. For example, if mass flow rate is expected to increase but it actually decreases, the camshaft phase is in error.

In some examples, the control of the valve actuator is performed when substantially no combustion is demanded from the internal combustion engine. The control may be performed during engine overrun. An advantage is that a subtle change in negative overrun torque would go substantially unnoticed.

In some examples, the requirement signal comprises a diagnostic requirement signal. An advantage is reduced driver disruption, as the above functions are performed infrequently at periodic intervals (e.g. from the range 20-50 k miles) or during maintenance. In other examples, the requirement signal comprises a torque demand signal, so that the above function can be performed during normal use of the vehicle, when torque demand does. An advantage is improved accuracy, because trends can be determined if the above functions are ‘always on’.

According to another aspect of the invention there is provided an internal combustion engine comprising the control system. In some examples, the internal combustion engine is provided without a camshaft position sensor.

According to another aspect of the invention there is provided a vehicle comprising the control system, or the internal combustion engine.

According to another aspect of the invention there is provided a method for controlling a valve actuator for an internal combustion engine, the method comprising: receiving a requirement signal indicative of a requirement for valve actuation with a first valve timing characteristic; receiving an expected flow signal indicative of expected mass flow rate of air, associated with the first valve timing characteristic; controlling the valve actuator to provide the first valve timing characteristic; receiving an actual flow signal indicative of actual mass flow rate of air, associated with the control of the valve actuator; causing comparison of the actual flow signal with the expected flow signal; and causing an action to be performed in dependence on the comparison, wherein the action comprises a compensation action and/or a fault reporting action.

According to another aspect of the invention there is provided computer software that, when executed, is arranged to perform the method. According to another aspect of the invention there is provided a non-transitory, computer-readable storage medium storing instructions thereon that, when executed by one or more electronic processors, causes the one or more electronic processors to carry out the method.

In some examples, the one or more controllers collectively comprise: at least one electronic processor having an electrical input for receiving the requirement signal and for receiving the expected flow signal and for receiving the actual flow signal; and at least one electronic memory device electrically coupled to the at least one electronic processor and having instructions stored therein; and wherein the at least one electronic processor is configured to access the at least one memory device and execute the instructions thereon so as to cause the vehicle to perform the functions of control, cause comparison, and cause an action to be performed.

According to another aspect of the invention there is provided a method comprising: determining the effect of adjustments of engine valve timing on airflow through an engine, for determining a phase error of a camshaft.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The Applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of a vehicle;

FIG. 2 illustrates an example of an internal combustion engine;

FIG. 3A illustrates an example of a control system and FIG. 3B illustrates an example of a non-transitory computer-readable storage medium;

FIG. 4 illustrates an example of a method; and

FIG. 5 illustrates an example of a valve lift diagram.

### DETAILED DESCRIPTION

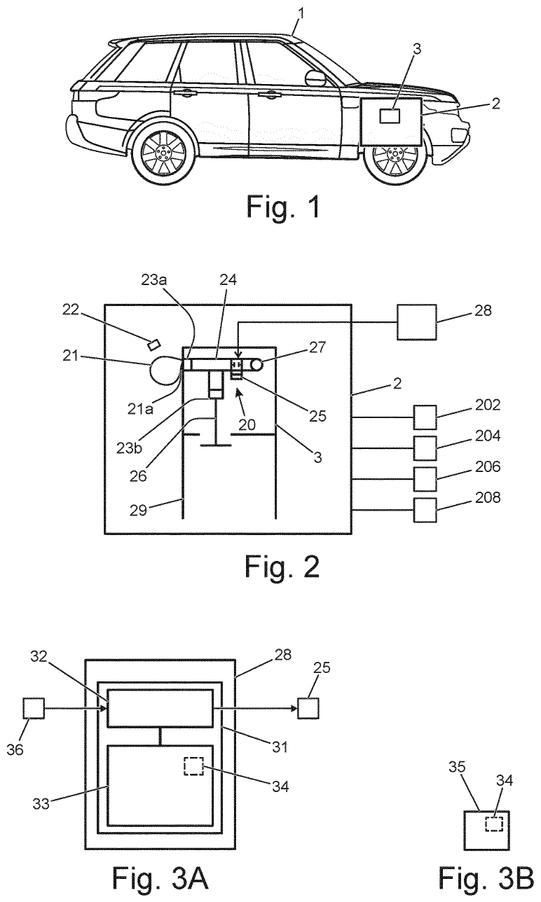

FIG. 1 illustrates an example of a vehicle 1 in which embodiments of the invention can be implemented. In some, but not necessarily all examples, the vehicle 1 is a passenger vehicle, also referred to as a passenger car or as an automobile. Passenger vehicles generally have kerb weights of less than 5000 kg. In other examples, embodiments of the invention can be implemented for other applications, such as industrial vehicles, air or marine vehicles.

The vehicle 1 comprises an internal combustion engine (‘engine’) 2. The engine 2 comprises a valvetrain 3.

FIG. 2 shows the engine 2 and specific components of the valvetrain 3 wherein the valvetrain 3 is electro-hydraulically actuated and enables CVVL for one or more intake valves. In other examples, the valvetrain 3 may be electromagnetic, or another equivalent that enables CVVL. In addition, the valvetrain 3 may be applied to exhaust valves.

FIG. 2 shows a camshaft-driven valve actuator 20 of the valvetrain 3, for actuating an intake valve. The valve actuator lobe 21a on the camshaft actuates a first piston 23a to displace hydraulic fluid within a hydraulic chamber 24. The displaced hydraulic fluid in turn displaces a second piston 23b which actuates an intake valve 26 of an engine combustion chamber 29.

A solenoid valve 25 controls the flow of hydraulic fluid through an outlet 27 of the hydraulic chamber 24 such that actuation of the first piston 23a can have the effect of actuating the intake valve 26 or pumping hydraulic fluid through the outlet 27 (thereby not actuating the intake valve 26), depending on whether the solenoid valve 25 is open or closed. Intake valve opening timing, closing timing, opening duration and lift can therefore be controlled by controlling the solenoid valve 25. Although FIG. 2 shows a solenoid valve 25, a known alternative varying device could be provided in other examples.

Although FIG. 2 shows one valve per valve actuator, in other examples one valve actuator could actuate multiple valves.

Although various aspects of the invention are applied to camshaft driven engines, they may also apply to certain camless engines in which a phase error of the equivalent actuating element by wear or incorrect servicing may be otherwise unaccounted for.

In FIG. 2, but not necessarily all examples, the camshaft 21 is a fixed-phase camshaft. A camshaft position sensor 22 is illustrated in FIG. 2, but it could advantageously be omitted according to various aspects of the present invention. If the camshaft phase is controlled by a variable camshaft timing system, then the camshaft position sensor 22 may be used. The camshaft position sensor 22 may be a hall effect sensor, an optical sensor, an inductive sensor, or the like, for detecting camshaft position. Comparison of signals between a camshaft position sensor 22 and a crankshaft position sensor enables camshaft phase errors to be determined.

FIG. 2 also symbolically illustrates an optional throttle valve 202, an optional forced induction subsystem 204; an optional air bypass valve 206; and an optional exhaust gas recirculation subsystem 208.

FIG. 2 illustrates a control system 28 capable of controlling one or more functions of the valvetrain 3. FIG. 3A illustrates the control system 28 in more detail.

The control system 28 may comprise means to cause any one or more of the methods described herein to be performed, at least in part. The control system 28 may comprise one or more (electronic) controllers. One controller 31 is shown in FIG. 3A.

The controller 31 of FIG. 3A includes at least one electronic processor 32; and at least one electronic memory device 33 electrically coupled to the electronic processor 32 and having instructions 34 (e.g. a computer program) stored therein, the at least one electronic memory device 33 and the instructions 34 configured to, with the at least one electronic processor 32, cause any one or more of the methods described herein to be performed.

The controller 31 of FIG. 3A comprises an electrical input for receiving information from one or more sensors 36 and/or other controllers. A non-exclusive list of possible sensors 36 is: a mass air flow sensor (MAF), an engine speed sensor, an oxygen/lambda sensor, a manifold absolute pressure (MAP) sensor, a knock sensor, a fuel pressure/temperature sensor, a throttle position sensor, a camshaft position sensor 22, a crankshaft position sensor, a coolant temperature sensor, an air-fuel ratio meter, a vehicle speed sensor, an oxygen or lambda sensor, or a combination thereof.

The controller 31 of FIG. 3A comprises an electrical output for transmitting processed output signals in dependence on the input signals. An example output signal is a command to cause the solenoid valve 25 to open or close at a particular time that provides a desired valve timing characteristic, based on a known or assumed camshaft phase and calibration information stored in the computer program. If the camshaft 21 is not a fixed-phase camshaft, e.g. a camshaft phaser is present, the controller 31 may be configured to determine an assumed camshaft phase in dependence on information from the camshaft phaser and/or a camshaft position sensor 22.

The instructions 34 may comprise an air flow model which models the mass flow rate of air through the engine 2. The air flow model may work in units of mass flow rate, however conversion into other units such as volumetric flow rate, or the use of speed-density models, is not excluded for other implementations. The air flow model may be used to influence at least air-fuel ratio. The air flow model may be used to influence valve timing/lift, to optimise air-fuel mixing.

The air flow model is calibrated for the specific design of engine 2, including the required camshaft phase. If the engine design changes or the camshaft phase error increases, the air flow model may become inaccurate.

FIG. 3B illustrates a non-transitory computer-readable storage medium 35 comprising the computer program instructions 34 (computer software).

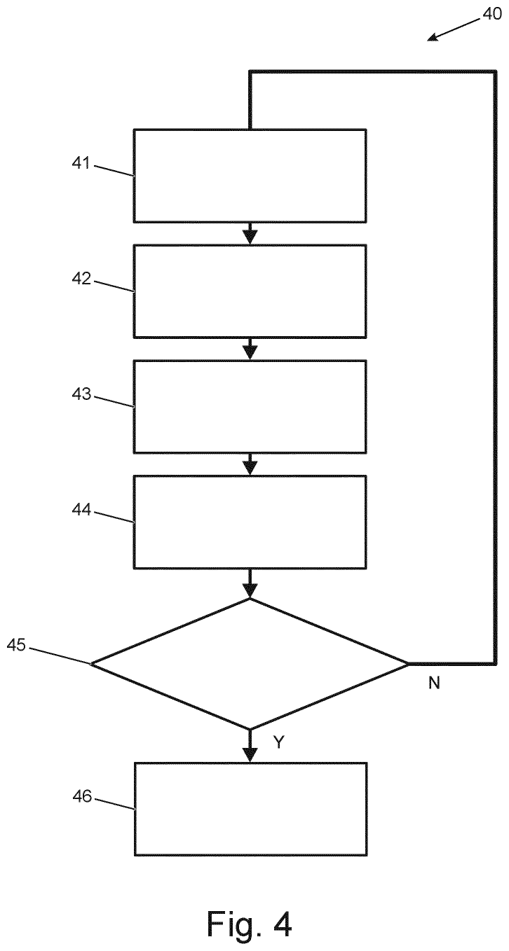

FIG. 4 illustrates an example method 40 which may be carried out by the control system 28 on the valvetrain 3 of FIG. 2 to perform one or more aspects of the present invention. The method 40 is a diagnostic method.

Two variants for the method 40 are disclosed herein. The first variant is described first and involves comparing actual mass flow rate with expected mass flow rate, at a single valve timing characteristic. The second variant involves comparison of mass flow rates at two or more valve timing characteristics.

At block 41, the method 40 comprises receiving a requirement signal. The requirement signal indicates a requirement to perform the diagnostic method 40. The diagnostic method 40 requires valve actuation with a first valve timing characteristic.

The first valve timing characteristic indicates a valve opening timing and/or valve closing timing. When the method 40 is carried out by the control system 28 on the valvetrain 3 of FIG. 2, the first valve timing characteristic indicates when to open the solenoid valve 25 and/or when to close the solenoid valve 25.

For the method 40, the first valve timing characteristic may be within a range of valve timing characteristics where a small change in the valve timing characteristic has a large effect on mass flow rate (examples are given later).

The requirement signal could be triggered by a diagnostic requirement signal from an external diagnostic device or from manual or automatic activation of a vehicle-internal diagnostic function. Automatic triggers could be programmed for set intervals, such as particular mileage or time intervals.

Alternatively, if the diagnostic method 40 is ‘always-on’, there would be no diagnostic requirement signal, and instead the requirement signal could be received whenever certain entry conditions are satisfied during normal driving. A benefit of entry conditions is minimising adverse effects on driveability and ensuring that the method is performed unnoticed.

An entry condition for the method 40 may optionally be defined which requires that substantially no combustion is demanded from the engine 2 during the diagnostic method 40, for example substantially zero torque demand. The entry condition may require that the vehicle 1 is in an overrun condition or an equivalent condition in which air is pumped through the engine 2 but substantially no combustion is required, e.g. zero positive torque demand.

Alternatively, an entry condition may be that partial valve lift events are required, even if torque demand is greater than zero. Partial valve lift events may be required at low engine speeds and loads, to improve in-cylinder swirl/tumble of the mixture.

The method 40 may only be performed to completion upon satisfaction of all required entry conditions.

The first valve timing characteristic may comprise late intake valve opening (LIVO) defining a partial valve lift event and/or early intake valve closing (EIVC). The mass flow rate of aspirated air is sensitive to camshaft phase error during a partial or incomplete valve lift event. An explanation is provided below.

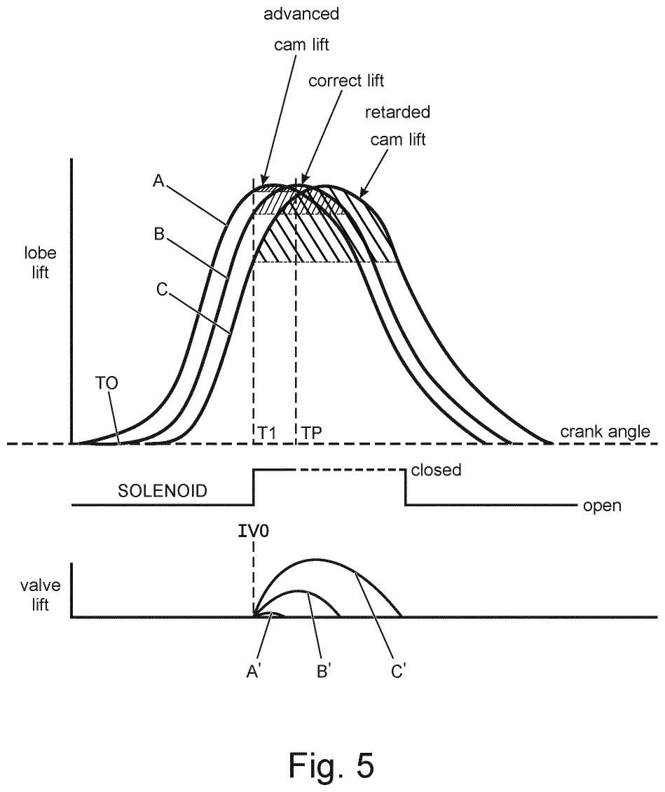

The valve lift diagram of FIG. 5 illustrates the amplifying effect of LIVO on mass flow rate for a given camshaft phase error. The upper graph of FIG. 5 shows lobe lift curves A, B and C, with lobe lift on the y-axis and crank angle, i.e. the angular position of a crankshaft configured to drive camshaft 21 as described above, on the x-axis. Lobe lift represents the displacement of the first piston 23a from its initial position by the lobe. In this illustrative example, the shape of the lobe 21a results in the lobe lift curve B in FIG. 5, with the start time of the lobe lift, i.e. the crank angle at which the lobe begins to displace the first piston 23a from its initial position, occurring at time TO, and peak lobe lift, i.e. the crank angle at which the point on the lobe at which the nose of the lobe intersects the lobe centreline comes in to contact with the first piston 23a, occurring at time TP. Curves A and C represent an advanced and a retarded cam phase respectively. It will be appreciated that the term ‘time’ in this context refers to a point in time during a rotation of the crankshaft at a given fixed engine speed (i.e. there is no change in engine speed between time TO and time TP).

The middle graph of FIG. 5 illustrates the state of the solenoid valve 25 and has the same x-axis as the upper graph. Lobe lift is only translated into valve lift, i.e. displacement of the intake valve 26 relative to its fully closed position, when the solenoid valve 25 is closed.

The lower graph of FIG. 5 illustrates valve lift curves A′, B′ and C′, with valve lift on the y-axis. The x-axis is the same as the middle and upper graphs. Valve lift curve A′ shows the valve lift for lobe lift curve A. Valve lift curve B′ shows the valve lift for lobe lift curve B. Valve lift curve C′ shows the valve lift for lobe lift curve C. For ease of comparison, the valve lift plots A′-C′ are also superimposed onto the respective lobe lift curves A-C of the upper graph using hatching. In all three cases, LIVO is performed by closing the solenoid valve 25 at time T1 so that the intake valve 26 is only open for a fraction of a full rotation of the cam. As described above, the term ‘time’ in this context refers to a point in time during a rotation of the crankshaft at a given fixed engine speed (i.e. there is no change in engine speed between time TO and time T1, or between time T1 and time TP).

Lobe lift curve B (‘correct lift’) produces a first valve lift curve B′, and an area under the first valve lift curve B′ represents the air charge provided by the valve lift, i.e. the mass of air inducted in to the combustion chamber 29 during the valve lift. For lobe lift curve B, there is no camshaft phase error. In an example implementation, the intake valve opens at 60 degrees of crankshaft rotation after piston top dead centre (TDC), and the peak valve lift is 1 mm from the fully closed position of the intake valve 26.

Curve A (‘advanced cam lift’) produces a second valve lift curve A′, and an area under the second valve lift curve represents the air charge. For lobe lift curve A, the camshaft phase is slightly advanced. In the example implementation, the camshaft phase is advanced by 10 degrees from its design value. The intake valve still opens at 60 degrees after TDC. The peak valve lift is 0.25 mm, which is lower than 1 mm as required. The mass flow rate may be only 10% of its expected value. Therefore, a mass flow rate which is less than expected provides an indication of an advanced cam phase.

Curve C (‘retarded cam lift’) produces a third valve lift curve C′, and an area under the third valve lift curve represents the air charge. For lobe lift curve C, the camshaft phase is slightly retarded. In the example implementation, the camshaft phase is retarded by 10 degrees from its design value. The intake valve still opens at 60 degrees after TDC. The peak valve lift is 2 mm, which is higher than 1 mm as required. The mass flow rate may be 500% of its expected value. Therefore, a mass flow rate which is greater than expected provides an indication of a retarded camshaft phase.

The air charge for valve lift curve A′ is significantly lower than the air charge for valve lift curve B′, and the air charge for valve lift curve C′ is significantly higher than the air charge for valve lift curve B′.

The sensitivity of admitted air charge to camshaft phase error is greater when the opening time T1 is proximal to the peak lobe lift time TP. The sensitivity is also greater when the lobe gradient is steep at the contact point when valve opening occurs. The total valve lift and valve lift duration are very sensitive to these variables. The mass flow rate of air is dependent on the area under the valve lift curve (air charge), which is very sensitive to error when the required area under the curve is small, e.g. during LIVO events, hence the distinction between curves A′-C′ in FIG. 5. A similar principle can be observed for EIVC. For LIVO, a suitable range for the value of the opening time T1 can be from approximately 20 degrees after TDC to less than 90 degrees after TDC, to provide a good indication of camshaft phase error. Referring to FIG. 5, T1 may be closer to TP than to TO. In terms of valve lift, the range could be expressed as an opening time that gives a valve lift from greater than 0% to less than 50% of maximum possible valve lift associated with a full duration valve lift event.

Referring back to FIG. 4, block 42 comprises receiving an expected flow signal indicative of expected mass flow rate of air, associated with the first valve timing characteristic. The first valve timing characteristic may be as defined above. The expected flow signal may be expressed in the units of mass flow rate or as an expected voltage from an air flow model sensor (e.g. MAF sensor), or in any other appropriate form. The expected flow signal may be received from the air flow model. The air flow model may store a fixed predetermined relationship between valve timing characteristics and mass flow rates.

In the first variant of the method 40, just one valve timing characteristic is tested. The expected flow signal may indicate an expected quantity of mass flow rate for the first valve timing characteristic, as determined by the air flow model. If the mass flow rate is less than expected, the camshaft phase may be advanced, for example as demonstrated by curve A and for the reasons explained above in relation to FIG. 5. If the mass flow rate is greater than expected, the camshaft phase may be retarded, for example as demonstrated by curve C and for the reasons explained above in relation to FIG. 5.

To eliminate other possible influences on the discrepancy between actual mass flow rate and expected mass flow rate, such as a sticking throttle valve or solenoid valve 25, other diagnostics may be employed for other mass air flow-affecting subsystems of the vehicle 1. The method 40 may proceed if the other influences are not present.

At block 43, the valve actuator 20 is controlled to provide the first valve timing characteristic. The solenoid valve 25 could be closed at time T1, allowing the valve to open. In practice, the first valve timing characteristic may be maintained for multiple combustion cycles so that the change in mass flow rate reaches a steady state. Noise can therefore be averaged out. The expected and actual flow signals can represent averages or steady-state values. In other examples, the method 40 may be repeated independently for each individual intake stroke.

Further, the first valve timing characteristic may be applied to multiple valve actuators rather than just one valve actuator. The expected and actual flow signals can represent averages across multiple valve actuators, so that the effect of individual faulty valve actuators as a potential cause of any mass air flow discrepancy in individual cylinders can be averaged out.

Control outputs of other mass air-flow affecting subsystems of the vehicle 1 could be held constant during block 43, to reduce noise factors. The throttle valve could be held fully open, for example. Turbocharger boost levels could be held constant. Exhaust gas recirculation could be held constant.

At block 44, the method 40 comprises receiving an actual flow signal indicative of actual mass flow rate of air, associated with the control of the valve actuator at block 43.

The actual flow signal could be calculated from an actual reading from an air flow model sensor (e.g. MAF sensor). The actual flow signal could be received from the MAF sensor directly or from the air flow model.

At block 45, the method 40 comprises causing comparison of the actual flow signal with the expected flow signal. As stated above, if the actual mass flow rate is less than expected, the camshaft phase may be advanced (for example as demonstrated by curve A). If the actual mass flow rate is greater than expected, the camshaft phase may be retarded (for example as demonstrated by curve C).

Block 45 may be implemented as a decision block. If a camshaft phase error condition is satisfied, the method 40 may proceed to block 46, otherwise it may loop back to an earlier block (optionally block 41 in FIG. 4). The camshaft phase error condition may be satisfied when the difference between actual and expected mass flow rates is above a threshold.

In some examples, determining whether the camshaft phase error condition is satisfied may be dependent on additional measurements of other variables indicative of a cam phasing error. For example, additional measurements could comprise measuring the size and/or shape of an intake manifold pressure dip associated with the first valve timing characteristic. Additional measurements could comprise measuring a dip in engine speed caused by variable combustion chamber filling during an intake stroke.

At block 46, the method 40 comprises causing an action to be performed in dependence on the comparison, wherein the action comprises a compensation action and/or a fault reporting action and/or determining camshaft phase information.

The camshaft phase information may indicate that a discrepancy between actual and required camshaft phase exists. The camshaft phase information may indicate an estimated amount of the discrepancy. The camshaft phase information may indicate an estimated camshaft phase.

The fault reporting action may cause a fault indicator to be generated indicating that a discrepancy exists between actual and expected camshaft phase. The fault indicator may be stored in the electronic memory device 33 and read by a diagnostic device such as an OBD2 reader. The fault indicator may cause a human-machine interface of the vehicle 1 or a diagnostics device to display a visual indication of the fault indicator.

If the fault indicator is generated while the vehicle is in customer-use, the fault reporting action may prompt the user of the vehicle 1 to take the vehicle 1 to a service station. Optionally, the vehicle 1 may enter a limp home mode or the engine 2 may be stopped. This would protect the engine 2 from valve collision or damage to exhaust gas treatment systems. A ‘severe’ camshaft phase error condition could be defined, that is satisfied based on greater phase errors than the phase error required by the above (regular) camshaft phase error condition.

If the action of block 45 comprises a compensation action, the compensation action may influence control of one or more vehicle subsystems to reduce the effect of a difference between actual and expected flow signals on one or more engine characteristics, in dependence on the camshaft phase information. The vehicle subsystems include spark plugs, fuel injectors, etc. The compensation action may be implemented as a correction to be applied to a fuelling calculation, an ignition timing (if spark ignited) calculation, or any other relevant calculations.

In some examples, the compensation action could be to control one or more vehicle subsystems to reduce the difference between actual and expected flow signals. For example, the vehicle subsystem may comprise the valve actuator 20. If the camshaft phase error causes the actual mass air flow rate to be less than expected, intake valve lift/duration may be increased. If the camshaft phase error causes the actual mass air flow rate to be more than expected, the intake valve lift/duration may be decreased.

The vehicle subsystem may comprise a throttle valve 202. The throttle valve may be opened more if an airflow increase is required to reduce the difference, and opened less if an airflow reduction is required.

The vehicle subsystem may comprise a forced induction subsystem 204, e.g. turbocharger. The turbocharger boost level may be increased if an airflow increase is required to reduce the difference, and may be decreased if an airflow reduction is required.

The vehicle subsystem may comprise an exhaust gas recirculation system 208. The recirculation may be decreased if an airflow increase is required to reduce the difference. The recirculation may be increased if an airflow reduction is required.

The vehicle subsystem may comprise an air bypass valve 206 for causing air to bypass the engine 2. The bypass may be decreased if an airflow increase is required to reduce the difference. The bypass may be increased if an airflow reduction is required.

It would be appreciated that the same method 40 would work on other valvetrains than the one shown in FIG. 2, that are capable of providing the required valve timing characteristics.

In the second variant of the method 40, the effect of changing from one valve timing characteristic to another may be compared. Specifically, two or more valve timing characteristics, each comprising different values of intake valve opening timing and/or closing timing and/or valve lift and/or opening duration, are performed and the actual difference in mass flow rate of air in to the combustion chamber 29 provided by the different valve timing characteristics is compared to an expected difference. Blocks 41 and 46 may be the same.

In the second variant, the expected flow signal of block 42 may be indicative of an expected change in mass flow rate, when changing from a second valve timing characteristic to another valve timing characteristic such as to the first valve timing characteristic. The change may be expressed as a quantity or as a sign of the change (positive or negative).

In the second variant, the control system 28 may control the valve actuator 20 to provide a second valve timing characteristic, and may measure the mass flow rate for determining the expected flow signal. The second valve timing characteristic may be associated with an expected peak in the mass flow rate. For instance, the peak could be the maximum possible mass flow rate, enabled by opening the intake valve at TDC or slightly before TDC and closing the valve 26 around bottom dead centre (BDC) or slightly after BDC. In block 43 (second variant), the valve actuator 20 may also be controlled to provide the first valve timing characteristic after (or before) the second valve timing characteristic, for example the intake valve opening timing may be advanced or retarded when changing from the second to the first valve timing characteristic.

Advancing intake valve opening timing from an opening timing expected to give the maximum possible mass flow rate should, in theory, result in no increase in mass flow rate. Retarding the intake valve opening timing should, in theory, result in an immediate decrease in mass flow rate due to lower valve lift.

However, if the camshaft phase is incorrectly advanced, the mass flow rate will increase in response to advancing the intake valve opening timing from the timing expected to give the maximum possible mass flow rate. Therefore, if the comparison reveals an increase of mass flow rate in response to advancing intake valve opening timing, the camshaft phase may be incorrectly advanced. Further, the mass flow rate may reduce by a greater amount when expected in response to retarding the intake valve opening timing from the timing expected to give the maximum possible mass flow rate. Therefore, if the comparison reveals a greater reduction of mass flow rate in response to retarding the intake valve opening timing, the camshaft phase may be incorrectly advanced.

If the camshaft phase is incorrectly retarded, the mass flow rate will not initially decrease in response to initially retarding intake valve opening timing from the timing expected to give the maximum possible mass flow rate, and may stay the same. Therefore, if the comparison reveals no immediate decrease of mass flow rate in response to retarding intake valve opening timing, the camshaft phase may be incorrectly retarded.

The actual flow signal of block 44 (second variant) may be indicative of an actual change in mass flow rate, associated with changing from the second valve timing characteristic to the first valve timing characteristic. The intake valve opening timing may be advanced or retarded relative to the second valve timing characteristic. The change may be expressed as a quantity or as a sign of the change (positive or negative).

The comparison of block 45 (second variant) comprises comparing the expected change in mass flow rate against the actual change. If the actual change has a positive sign, then the second valve timing characteristic is not aligned with the expected peak mass flow rate. Therefore, the camshaft phase is deemed incorrect. Additional sweeping measurements in the advancing and/or retarding directions enables the method to ascertain whether the camshaft phase is advanced or retarded from its intended phase, and even by how much.

For purposes of this disclosure, it is to be understood that the controller(s) 31 described herein can each comprise a control unit or computational device having one or more electronic processors. A vehicle 1 and/or a system thereof may comprise a single control unit or electronic controller or alternatively different functions of the controller(s) may be embodied in, or hosted in, different control units or controllers. A set of instructions 34 could be provided which, when executed, cause said controller(s) or control unit(s) to implement the control techniques described herein (including the described method(s)). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on or more electronic processors, optionally the same one or more processors as the first controller. It will be appreciated, however, that other arrangements are also useful, and therefore, the present disclosure is not intended to be limited to any particular arrangement. In any event, the set of instructions described above may be embedded in a computer-readable storage medium 35 (e.g., a non-transitory computer-readable storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM ad EEPROM); flash memory; or electrical or other types of medium for storing such information/instructions.

It will be appreciated that various changes and modifications can be made to the present invention without departing from the scope of the present application.

The term ‘combustion torque demand’ as described herein refers to a torque demand that requires internal combustion in order to be satisfied, e.g. a positive torque demand. Combustion torque demand may be dependent on a throttle position sensor reading, and other torque demands by other components of the vehicle powered by the engine.

The blocks illustrated in FIG. 4 may represent steps in a method and/or sections of code in the computer program 34. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed. Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-15. (canceled)

16. A control system for controlling a valve actuator for an internal combustion engine, the control system comprising one or more controllers, the control system being configured to:
receive a requirement signal indicative of a requirement for valve actuation with a first valve timing characteristic;
receive an expected flow signal indicative of an expected mass flow rate of air associated with the first valve timing characteristic;
control the valve actuator to provide the first valve timing characteristic;
receive an actual flow signal indicative of an actual mass flow rate of air associated with the control of the valve actuator;
cause comparison of the actual flow signal with the expected flow signal; and
cause an action to be performed in dependence on the comparison, wherein the action comprises at least one of a compensation action, a fault reporting action, and determining camshaft phase information.

17. The control system of claim 16, wherein performance of the action obviates a requirement for a camshaft phase error function of a camshaft position sensor, enabling the internal combustion engine to be optionally provided without the camshaft position sensor.

18. The control system of claim 16, wherein the internal combustion engine is a fixed-phase camshaft internal combustion engine and the valve actuator enables at least variable valve timing.

19. The control system of claim 16, wherein the valve actuator is at least one of
configured to enable substantially continuous adjustment of at least valve timing characteristics,
an electrohydraulic valve actuation system,
an electromagnetic valve actuation system, and
for at least intake valves.

20. The control system of claim 16, wherein the first valve timing characteristic comprises late valve opening and/or early valve closing and/or wherein the first valve timing characteristic is associated with a valve-open duration, and wherein a magnitude of variation of the actual flow signal from the expected flow signal decreases for greater valve-open durations.

21. The control system of claim 16, wherein the compensation action influences control of a vehicle subsystem to reduce the difference between actual and expected flow signals and/or influences control of a vehicle subsystem to reduce the effect of the difference on one or more engine characteristics.

22. The control system of claim 21, wherein the vehicle subsystem comprises one or more of: the valve actuator, a throttle valve, a forced induction subsystem, an air bypass valve, or an exhaust gas recirculation subsystem.

23. The control system of claim 16, wherein the fault reporting action causes a fault indicator to be stored that indicates that a discrepancy exists between an actual and an expected camshaft angular position relative to a crankshaft angular position.

24. The control system of claim 16, wherein at least the actual mass flow rate of air is determined using an air flow model capable of measuring a quantity of air inducted into the internal combustion engine using information from one or more sensors.

25. The control system of claim 16, wherein the expected mass flow rate comprises at least one of an expected quantity of a mass flow rate of air, and an expected sign of a difference in mass flow rate of air when changing from a second valve timing characteristic to the first valve timing characteristic.

26. The control system of claim 25, wherein
the actual flow signal comprises an actual sign of a difference in mass flow rate of air when changing from the second valve timing characteristic to the first valve timing characteristic, and
the action is caused to be performed in dependence on the expected sign being negative and the actual sign being positive.

27. The control system of claim 16, wherein the control of the valve actuator is performed when substantially no combustion is demanded from the internal combustion engine.

28. The control system of claim 16, wherein the requirement signal comprises a diagnostic requirement signal or a torque demand signal.

29. A vehicle comprising the control system of claim 16.

30. A method for controlling a valve actuator for an internal combustion engine, the method comprising:
receiving a requirement signal indicative of a requirement for valve actuation with a first valve timing characteristic;
receiving an expected flow signal indicative of an expected mass flow rate of air associated with the first valve timing characteristic;
controlling the valve actuator to provide the first valve timing characteristic;
receiving an actual flow signal indicative of an actual mass flow rate of air associated with the control of the valve actuator;
causing comparison of the actual flow signal with the expected flow signal; and
causing an action to be performed in dependence on the comparison, wherein the action comprises at least one of a compensation action, a fault reporting action, and determining camshaft phase information.

31. A non-transitory, computer-readable storage medium storing instructions that, when executed by one or more electronic processors, causes the one or more electronic processors to carry out the method of claim 30.
